(19) United States
(12) Patent Application Publication
(10) Pub. No.: US 2026/0105379 A1
(43) Pub. Date: Apr. 16, 2026

(54) RANKING MODEL MODELING, PRODUCT OBJECT SEARCH METHOD, DEVICE, AND MEDIUM

(71) Applicant: Hangzhou Alibaba International Internet Industry Co., Ltd., Hangzhou City (CN)

(72) Inventors: Ben CHEN, Hangzhou (CN); Linbo JIN, Hangzhou (CN); Xinxin WANG, Hangzhou (CN)

(21) Appl. No.: 19/419,835

(22) Filed: Dec. 15, 2025

Related U.S. Application Data
(63) Continuation of application No. PCT/CN2024/079464, filed on Feb. 29, 2024.

(30) Foreign Application Priority Data
Jun. 16, 2023 (CN) 202310723141.5

(51) Int. Cl. G06N 20/00; G06F 16/338

(52) U.S. Cl. CPC G06N 20/00; G06F 16/338

(57) ABSTRACT

Embodiments of the present disclosure provide ranking model modeling, a product object search method, a device, and a medium; The method includes: deleting search-associated data of a target language site from search-associated data to obtain target search-associated data; filtering feature data from the target search-associated data according to a preset rule to construct training data; constructing a ranking model; and training the ranking model based on the training data to obtain a ranking model that satisfies specified conditions. This can remove the influence of the target language on the data, make the target search-associated data for each language more balanced, eliminate the impact of uneven data distribution across various sites on low-traffic languages, and result in a ranking model that supports various languages, enabling accurate feedback for searches in various languages;

### CROSS-REFERENCE TO RELATED APPLICATION

This application is a Continuation Application of International Patent Application No. PCT/CN2024/079464, filed on Feb. 29, 2024, which is based on and claims priority to and benefits of Chinese Patent Application No. 202310723141.5 filed with the China National Intellectual Property Administration on Jun. 16, 2023, titled “RANKING MODEL MODELING, PRODUCT OBJECT SEARCH METHOD, DEVICE, AND MEDIUM.” The above-referenced applications are incorporated herein by reference in their entirety.

### TECHNICAL FIELD

The present disclosure relates to the field of computer technology, and in particular, to a method for constructing a ranking model, a search method for a product object, an electronic device, and a storage medium.

### BACKGROUND

A cross-border e-commerce website provides e-commerce services for cross-border transactions, where users can purchase product objects from various different countries on the cross-border e-commerce website. Because the cross-border e-commerce website supports the sale of product objects between different pairs of countries, it also supports the languages of different countries.

When a user searches on a cross-border e-commerce website, product objects are typically filtered based on a keyword entered by the user. However, because the e-commerce website supports multiple languages, and the data volume of data such as users and products corresponding to different languages on the e-commerce website varies greatly, this affects the ranking model. Product objects corresponding to languages with a large data volume usually rank higher in search ranking and are more easily fed back to the user during a search. In contrast, product objects in a minority language, due to a smaller data volume, tend to rank lower in search ranking and are fed back less frequently during a search. This, in turn, affects the querying and sales of product objects for users who sell through minority languages.

### SUMMARY

Embodiments of the present disclosure provide a method for constructing a ranking model to improve the accuracy of the ranking model.

Correspondingly, embodiments of the present disclosure also provide a method for a product object, an electronic device, and a storage medium to ensure the implementation and application of the above system.

To solve the above problems, an embodiment of the present disclosure discloses a method for constructing a ranking model, the method including:
deleting search-associated data of a target language site from search-associated data to obtain target search-associated data;
filtering feature data from the target search-associated data according to a preset rule to construct training data;
constructing a ranking model; and
training the ranking model based on the training data to obtain a ranking model that satisfies specified conditions.

Optionally, before deleting the search-associated data of the target language site from the search-associated data to obtain the target search-associated data, the method further includes:
acquiring search-associated data for each language site; and
determining data volume information corresponding to each language site based on the search-associated data, and determining the target language site based on the data volume information.

Optionally, filtering the feature data from the target search-associated data according to the preset rule to construct the training data includes:
obtaining sampling information of the target search-associated data of each language site; and
collecting data of a target feature from the target search-associated data of each language site according to the sampling information to construct the training data.

Optionally, obtaining the sampling information of the target search-associated data of each language site includes:
determining data volume information and behavior information for each language site based on the target search-associated data of each language site; and
determining the sampling information of the target search-associated data for each language site based on the data volume information and the behavior information.

Optionally, the method further includes:
extracting feature data of each feature from the associated data, and analyzing correlation information between feature data and the behavior information; and
filtering the target feature based on the correlation information.

Optionally, the method further includes: for each product object, constructing a site difference feature as the target feature.

Optionally, constructing the site difference feature for each product object includes:
generating a difference feature based on at least one of a language feature, a product object feature, and a conversion feature;
determining a site feature of a site corresponding to the product object; and
concatenating the difference feature and the site feature to obtain a corresponding site difference feature.

Optionally, generating the difference feature based on at least one of the language feature, the product object feature, and the conversion feature includes:
acquiring an associated feature of the product object, the associated feature including an interaction depth feature of a language, a conversion rate feature of the product object, and a service quality feature of a seller user;
determining the conversion feature of the product object based on the associated feature; and
concatenating the conversion feature, the language feature, and the product object feature to determine a corresponding difference feature.

Optionally, constructing the ranking model includes:
determining an activation function, and adding the activation function to the neural network model to construct the ranking model.

Optionally, determining the target language site based on the data volume information includes:
in a case where the data volume information corresponding to a site exceeds a target threshold, determining the site as the target language site, where a language of the site is a target language.

An embodiment of the present disclosure also discloses a product object search method, the method including:
receiving a search request, the search request carrying a keyword;
performing a search based on the keyword to determine a plurality of product objects;
analyzing the plurality of product objects based on a ranking model to filter product objects, where the ranking model is obtained through training based on training data, the training data is constructed based on feature data filtered from target search-associated data according to a preset rule, and the target search-associated data is determined by deleting a target language site from search-associated data; and
generating a search result based on the filtered product objects and feeding back the search result.

Optionally, analyzing the plurality of product objects based on the ranking model to filter the product objects includes:
collecting data of a target feature from feature data of the product objects and inputting the data into the ranking model; and
filtering the product objects based on an output result of the ranking model.

An embodiment of the present disclosure also discloses an electronic device, including: a processor, and a memory communicatively connected to the processor; the memory stores computer-executable instructions; the processor executes the computer-executable instructions stored in the memory to implement the method as described in the embodiments of the present disclosure.

An embodiment of the present disclosure also discloses a computer-readable storage medium, where the computer-readable storage medium stores computer-executable instructions, and the computer-executable instructions, when executed by a processor, are used to implement the method as described in the embodiments of the present disclosure.

Compared with the prior art, embodiments of the present disclosure include the following advantages:

In embodiments of the present disclosure, the search-associated data of a target language site is deleted from the search-associated data to obtain target search-associated data, thereby removing the influence of the target language on the data and making the target search-associated data for each language more balanced. Then, feature data is filtered from the target search-associated data according to a preset rule to construct training data, which allows for the selection of desired feature data as training data. A ranking model is then constructed and trained based on the training data to obtain a ranking model that satisfies specified conditions. This can eliminate the impact of uneven data distribution across various sites on low-traffic languages, resulting in a ranking model that supports various languages and enables accurate feedback for searches in various languages.

### BRIEF DESCRIPTION OF THE DRAWINGS

FIG. 1 is a step flowchart of an embodiment of a method for constructing a ranking model of the present disclosure;

FIG. 2 is a step flowchart of another embodiment of a method for constructing a ranking model of the present disclosure;

FIG. 3 is a step flowchart of an embodiment of a product object search method of the present disclosure;

FIG. 4 is a schematic structural diagram of an exemplary apparatus provided by an embodiment of the present disclosure.

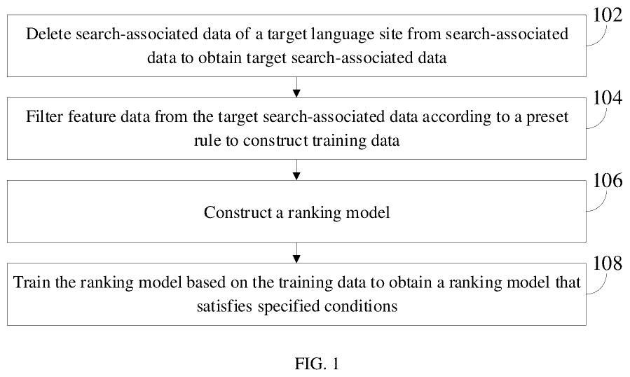

### DETAILED DESCRIPTION OF THE EMBODIMENTS

To make the above objectives, features, and advantages of the present disclosure more apparent and understandable, the present disclosure will be further described in detail below with reference to the accompanying drawings and specific embodiments.

Embodiments of the present disclosure can be applied in the search domain. A cross-border e-commerce website provides services for seller users and buyer users from hundreds of countries and in multiple languages. Therefore, websites can be set up in different countries for ease of access. Different countries use different languages. For example, English-speaking countries such as the United Kingdom and the United States use English, and these websites can be called English sites. A German website uses German, and the corresponding website can be called a German site. Therefore, a cross-border e-commerce website includes sites in various languages.

In embodiments of the present disclosure, when training a ranking model, the influence of large-data-volume languages on ranking can be reduced, thereby improving the accuracy of the ranking model.

Step 102, delete search-associated data of a target language site from search-associated data to obtain target search-associated data.

Search-associated data is acquired from a database of the cross-border e-commerce website. The search-associated data includes various data related to searching for product objects, for example, product object data, keywords corresponding to product objects, search click data, store data, and so on. Therefore, the search-associated data for each language site can be acquired from the database of the cross-border e-commerce website. Specifically, the language of a site is primarily its default language. For example, sites corresponding to the United Kingdom, the United States, etc., are English sites, a Japanese site uses Japanese, a Korean site uses Korean, and so on.

Embodiments of the present disclosure construct a ranking model that supports searches in various languages. Specifically, some language sites have a large amount of data on the cross-border e-commerce website. If all languages are used together to train the ranking model, this large amount of data will affect the accuracy of the ranking model, leading to inaccurate ranking results. Therefore, a language with a large amount of data can be determined as a target language, the search-associated data of the target language site can be determined, and the search-associated data of the target language site can be deleted from the search-associated data. In embodiments of the present disclosure, deleting the search-associated data of the target language site does not mean deleting all data of the target language. Some search data corresponding to the target language will also exist on sites of other languages, so the search ranking for the target language will not be affected. For example, on a Korean language site in Korea, some users may also use English for searching. That is, the language of the site is the default language of the site, and there are no restrictions on the language used by users on the site. In embodiments of the present disclosure, a corresponding language can be set as the target language, and a site with this target language as its baseline language is a target language site, such as an English site. In some other embodiments, one or more target language sites can also be determined based on the data volume corresponding to the sites.

In an optional embodiment, before deleting the search-associated data of the target language site from the search-associated data to obtain the target search-associated data, the method further includes: acquiring the search-associated data for each language site; determining data volume information corresponding to each language site based on the search-associated data; and determining the target language site based on the data volume information. The search-associated data for each language site is acquired based on log data, etc. Then, the data volume information corresponding to each language site, such as data volume size, data volume proportion, etc., can be determined based on the search-associated data. The target language site is determined based on the data volume information. Specifically, the target language is usually one language but can also be more than one language, determined based on the data of each language site on the cross-border e-commerce website. In embodiments of the present disclosure, determining the target language site based on the data volume information includes: determining whether the data volume information corresponding to the language site exceeds a target threshold. If the data volume information corresponding to a certain language site exceeds the target threshold, then the language site is determined as the target language site. Specifically, the target threshold is a threshold for determining the target site, which can be a threshold for data volume size or a threshold for data proportion. For example, if the data volume of a certain site accounts for more than 60% of the total site data volume, or exceeds 50%, 40%, etc., it can be determined as a target language site.

In an exemplary cross-border e-commerce website, the historical logs of the English site account for nearly 65% of the entire website, while low-traffic language sites such as the Korean language, Japanese language, and Vietnamese language sites account for only less than 2%. If the data from all language sites are used for unified training, the features of the other minority language sites may be completely dominated by the English site. Therefore, in embodiments of the present disclosure, the search-associated data of the English site is deleted, and the search-associated data from multiple other language sites is used for training. It should be noted that in the data traffic of each non-English language sites, there is still nearly 30% of search data corresponding to English keywords, which can compensate for the proportion lost by deleting the search-associated data of the English site, enabling the ranking model that supports various languages to still have learning capability for English keywords.

Step 104, filter feature data from the target search-associated data according to a preset rule to construct training data.

The target search-associated data includes various data related to searches. However, not all data affects ranking, and different types of data have different impacts on ranking. Therefore, it is necessary to filter the required feature data to construct training samples.

Since data is acquired from each language site for training, and the traffic, user behavior, etc., corresponding to different language sites are different, it is also necessary to determine sampling information such as the sampling ratio for the data of each language site, and perform sampling according to this sampling information to obtain training data. Filtering the feature data from the target search-associated data according to the preset rule to construct the training data includes: obtaining sampling information of the target search-associated data of each language site; and collecting data of a target feature from the search data of each language site according to the sampling information to construct the training data. Obtaining the sampling information of the target search-associated data of each language site includes: determining data volume information and behavior information for each language site based on the target search-associated data of each language site; and determining the sampling information of the target search-associated data for each language site based on the data volume information and the behavior information.

Specifically, the traffic corresponding to the data of different language sites is different. Some language sites have high traffic, meaning many visiting users, while some language sites have low traffic, meaning little visit data. However, the amount of traffic is not directly proportional to the actual user interaction behavior on the site. That is, some sites have low traffic but a high conversion rate for product objects. Specifically, the conversion rate refers to the ratio of the number of users after using a single interaction behavior and overall function in a product object to the number of users before using it. Therefore, the data volume information, such as data volume proportion, for each language site can be determined based on the target search-associated data of each language site. Additionally, the conversion rate information corresponding to each language site can be determined based on user behavior information. Then, the sampling information, such as the sampling ratio for each language site, can be determined based on the data volume information and the conversion rate information. Therefore, embodiments of the present disclosure can adjust different sampling proportions for deep inquiry samples for different sites. Specifically, an inquiry refers to the process where one party in a transaction, for the purpose of buying or selling a product object, orally or in writing explores the transaction conditions with the other party. On an e-commerce website, a buyer user's visit to, adding to cart of, and communication with customers regarding a product object can all be called an inquiry.

Taking a cross-border e-commerce website as an example, based on the analysis of website log data, it is found that the data distribution of each site is also different. Among the language sites other than the English site, the top five language sites in terms of traffic are the Spanish language(ES) site, the French language (FR) site, the Russian language (RU) site, the Arabic language (AR) site, and the Turkish language (TR) site, which contribute nearly 60% of the traffic. In particular, the Spanish language(ES) site alone accounts for 30% of the total traffic. However, from the perspective of user conversion, the conversion rate of sites with a proportion of less than 5%, such as the Korean language site, the Japanese language site, and the Vietnamese language site, is higher than the conversion rate of the top five head sites in terms of traffic. To make the contributions of different language sites more uniform, different sampling proportions for deep inquiry samples can be adjusted for different sites. For example, behavior data from head sites with high traffic and low conversion can be sampled at a lower ratio, while behavior data from sites with tail traffic and high conversion rate can be sampled at a higher ratio, which can help alleviate the problem of sparse behavior data and long tail.

After determining the sampling information such as the sampling ratio, data of a target feature can be collected from the search data of each language site according to the sampling information to construct the training data. Specifically, since different data have different impacts on ranking, target features can also be analyzed and determined, and data of the target features can be collected.

In an optional embodiment, feature data of each feature is extracted from the associated data, correlation information between each feature data and behavior information is analyzed, and a target feature is filtered based on the correlation information. Specifically, the behavior information can be behavior information related to interaction with a product object, such as click behavior, visit behavior, add-to-cart behavior, purchase behavior, etc. The correlation information between each feature data and the behavior information can be analyzed. For example, the payment time of an order for a product object, the age of a brand, etc., are all weakly correlated features. Deleting such weakly correlated features can reduce the influence of irrelevant features. For example, importance scoring can be performed on various features of interaction behavior using a drop-rank method. The scoring range is between 0 and 1, and the importance is ranked from 0 to 1. Then, based on the scores and processing logic, features with a relatively small impact are eliminated. The drop-rank method can reduce the probability of low-importance features appearing in the neural network by adding a perturbation variable. This method can consider combinations between features and is effective for selecting the top N features, while also having a relatively small computational cost (training the model once is sufficient). Thus, nearly 50% of weakly correlated features, such as payment time and brand age, can be deleted through the above method.

In embodiments of the present disclosure, keywords are also determined as target features based on historical data. Historical data within a specified time period, such as search keywords, can be acquired, for example, for a specified time period of 1 month, 3 months, half a year, etc. Then, a language model (LM), such as a uni-gram, bi-gram model, can be used to train and analyze the historical data to calculate the degree of difference, conversion rate, and popularity among keywords and score them. This yields keywords corresponding to core attributes for each industry and each site, which are used as target features. By adding these keywords corresponding to core attributes as target features, the proportion of important features in the training data can be increased, and the dominance of core features can be enhanced. Through the mining of core attributes of different language sites and industries from the perspective of user needs, the click-through rate (CTR) of product objects increased by +13% in practical applications, verifying the correctness of this idea.

In embodiments of the present disclosure, a site difference feature is also constructed as a target feature for each product object. Specifically, the site difference feature is composed of a site feature combined with a difference feature. For example, the site feature and the difference feature are concatenated to obtain the difference feature. Specifically, the site feature is the feature of the site where the product object is located. The difference feature can be generated from the language feature, product object feature, and conversion feature corresponding to each product object. Specifically, the language feature is the feature corresponding to the language, for example, a corresponding feature value or vector value is set for each language as the feature of that language. The product object feature is the feature of the product object, which can be determined based on product object information, etc. The conversion feature is a feature obtained by converting multiple features of the product object and is a feature obtained by combining multiple features. For example, the corresponding conversion feature is determined by calculation based on multiple pieces of information such as language, conversion rate, service quality, etc. In an optional embodiment, an associated feature of the product object can be acquired. The associated feature includes an interaction depth feature of the language, a conversion rate feature of the product object, and a service quality feature of the seller user. The conversion feature of the product object is determined based on the associated feature. The conversion feature, the language feature, and the product object feature are concatenated to determine the corresponding difference feature. Specifically, the interaction depth feature of the language can be determined based on interaction data corresponding to the language, such as user consultation data for the product object. For example, it can be determined based on communication depth features of various frequencies on each multilingual site, basic product communication information on each multilingual site, etc.

By constructing language site difference features, the learning of differentiated product object representation under each site can be balanced, and at the same time, the unified learning of differentiated features of different sites by the same model is supported. This allows for a good optimization of both resource utilization and conversion efficiency.

Then, data of the target feature can be collected from the target search-associated data of each language site according to the sampling information to construct the training data.

Step 106, construct a ranking model.

To rank the search for product objects, a ranking model needs to be constructed first. Specifically, the ranking model can be constructed based on various ranking algorithms, neural network models, linear ranking models, tree models, deep learning models, etc. The ranking model can be determined based on click-through rate (CTR), visit rate, etc.

In embodiments of the present disclosure, the ranking model can be constructed based on a neural network model. Therefore, an activation function can be determined, and the activation function can be added to the neural network model to construct the ranking model. In embodiments of the present disclosure, multiple activation functions can be set. For example, activation functions include linear activation functions and non-linear activation functions: sigmoid, ReLU, ELU, Leaky ReLU, CReLU, ReLU6, SELU, Softplus, etc. Specifically, an activation function is a function added to a neural network, designed to help the network learn complex patterns in the data. In a neuron, the input undergoes a series of weighted sums and then acts on the activation function. Similar to a model based on neurons in the human brain, the activation function ultimately determines whether to transmit a signal and what to transmit to the next neuron. Thus, the efficiency of the neural network can be improved through adjustments. Specifically, sigmoid is a smoothened step function used for binary classification. ReLU (Rectified Linear Unit) is used to activate some neurons and increase sparsity. Leaky ReLU differs from ReLU in that it retains a constant leak on the negative axis, so that when the input information is less than 0, the information is not completely lost. ELU is the Exponential Linear Unit. CReLU is Concatenated Rectified Linear Units. ReLU6 is a Rectified Linear Unit that caps at 6, which is mainly for achieving good numerical resolution on mobile devices with low precision. SELU is the Scaled Exponential Linear Unit. The Softplus function can be seen as a smooth version of the ReLU function, and its derivative is exactly the Logistic function. Although the Softplus function also has the characteristics of one-sided suppression and a wide excitation boundary, it does not have sparse activation and will not sparsify the model.

The ranking model includes an embedding layer, which can convert input features into feature vectors. In embodiments of the present disclosure, the embedding layer can be determined based on loading personalized vectors, relevance model learning, etc., to initialize the parameters of the model. For example, a pre-trained identifier embedding layer can be loaded with personalized vectors to perform vector conversion for identifiers. A text embedding layer trained by a language representation model (BERT (Bidirectional Encoder Representations from Transformers)) can be loaded to perform vector conversion for text segments such as keywords. An embedding layer trained by a Graph Neural Network (GNN) can be loaded to perform vector conversion for corresponding features.

In an example, for a target feature input to the embedding layer, symbols therein can be identified through text analysis, and the text can be segmented to determine each text segment. Then, tokens of the text segments are determined, and an identifier for each token is determined. The semantic information, positional information, etc., of each token are analyzed and converted into a corresponding feature vector.

In the ranking model, each feature vector can be input into a Deep Neural Network (DNN) layer for dimensionality reduction processing, and the resulting dimensionally reduced vector is input into an attention network. Embodiments of the present disclosure can, based on relevance optimization experience, implement self-attention optimization for the keyword (query) and title in the ranking model, promoting a stronger representation of the query-title pair, and at the same time, enhancing the semantic matching capability in the ranking model to a certain extent.

In embodiments of the present disclosure, during the process of training the ranking model, an optimizer can also be used to improve the efficiency of training, making the training more stable and the model more robust.

Step 108, train the ranking model based on the training data to obtain a ranking model that satisfies specified conditions.

Each piece of training data can be input into the ranking model to determine a ranking result. Then, a loss function is determined based on the ranking result and the training data. The parameters of the ranking model are adjusted based on the loss function, and training continues until a ranking model that satisfies the condition is obtained.

In summary, the search-associated data of a target language site is deleted from the search-associated data to obtain target search-associated data, thereby removing the influence of the target language on the data and making the target search-associated data for each language more balanced. Then, feature data is filtered from the target search-associated data according to a preset rule to construct training data, which allows for the selection of desired feature data as training data. A ranking model is then constructed and trained based on the training data to obtain a ranking model that satisfies specified conditions. This can eliminate the impact of uneven data distribution across various sites on low-traffic languages, resulting in a ranking model that supports various languages and enables accurate feedback for searches in all languages.

On the basis of the above embodiments, an embodiment of the present disclosure also provides a method for constructing a ranking model, which can delete target language site data, delete weakly correlated features, add core key attributes, and eliminate the impact of uneven data distribution across various sites on low-traffic languages.

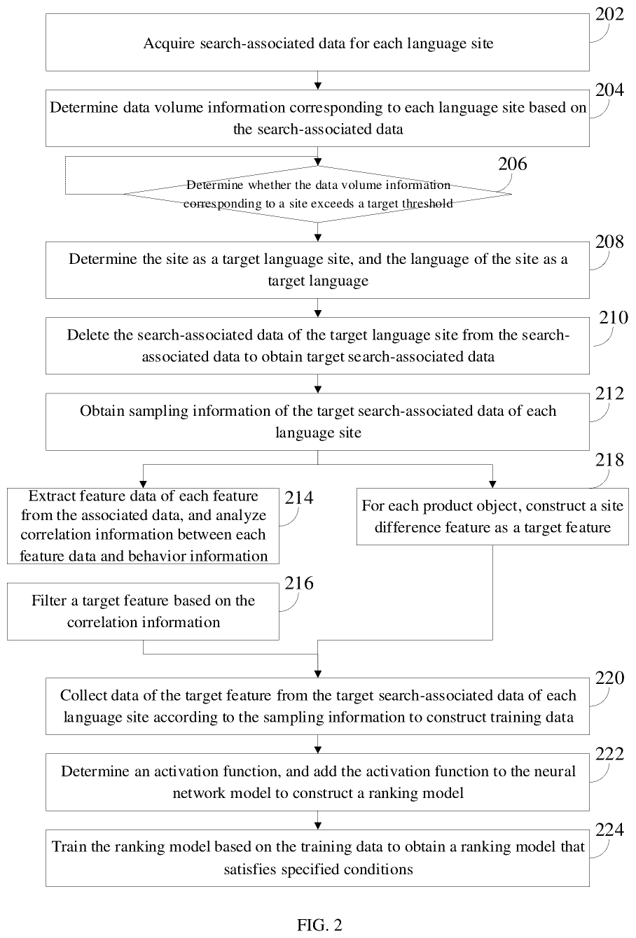

Referring to FIG. 2, a step flowchart of another embodiment of a method for constructing a ranking model of the present disclosure is shown.

Step 202, acquire search-associated data for each language site.

Step 204, determine data volume information corresponding to each language site based on the search-associated data.

Step 206, determine whether the data volume information corresponding to a site exceeds a target threshold.

If yes, proceed to step 208; if no, continue to check the languages of other sites.

Step 208, determine the site as a target language site, and the language of the site as a target language.

Step 210, delete the search-associated data of the target language site from the search-associated data to obtain target search-associated data.

Step 212, obtain sampling information of the target search-associated data of each language site.

Specifically, data volume information and behavior information for each language site are determined based on the target search-associated data of each language site; and the sampling information of the target search-associated data for each language site is determined based on the data volume information and the behavior information.

Step 214, extract feature data of each feature from the associated data, and analyze correlation information between each feature data and behavior information.

Step 216, filter a target feature based on the correlation information.

Step 218, for each product object, construct a site difference feature as a target feature.

Specifically, constructing the site difference feature for each product object includes: generating a difference feature based on at least one of a language feature, a product object feature, and a conversion feature; determining a site feature of a site corresponding to the product object; and concatenating the difference feature and the site feature to obtain a corresponding site difference feature.

Generating the difference feature based on at least one of the language feature, the product object feature, and the conversion feature includes: acquiring an associated feature of the product object, the associated feature including an interaction depth feature of a language, a conversion rate feature of the product object, and a service quality feature of a seller user; determining the conversion feature of the product object based on the associated feature; and concatenating the conversion feature, the language feature, and the product object feature to determine a corresponding difference feature.

Step 220, collect data of the target feature from the target search-associated data of each language site according to the sampling information to construct training data.

Step 222, determine an activation function, and add the activation function to the neural network model to construct a ranking model.

Step 224, train the ranking model based on the training data to obtain a ranking model that satisfies specified conditions.

In the embodiments of the present disclosure, the order of constructing the ranking model and determining the training data is not limited and can be determined in parallel according to requirements.

Compared to unified modeling for all sites, where a single model suffers from uneven training for minority languages, embodiments of the present disclosure remove the data of target language sites with a large data proportion, such as English site data, while using the search data of the target language in multilingual sites to ensure that the model takes the target language into account. Embodiments of the present disclosure also adjust different sampling proportions for deep inquiry samples for different language sites. Thus, sites with a large amount of visit data are set to a lower sampling ratio, while sites with a low amount of visit data are sampled at a higher ratio, which can help alleviate the problem of sparse behavior data and long tail.

Compared to independent ranking modeling per site, which leads to too many models and causes losses in resources and online performance, as well as the problem of insufficient data volume in some low-traffic scenarios, cross-modeling, and severe losses in retention and conversion, embodiments of the present disclosure can delete weakly correlated features when determining training data, add core key attributes, and also construct differentiated features for language sites, eliminating the interference of uneven data distribution across various sites on the performance for low-traffic languages.

Compared to regional modeling, there is the problem of inconsistent division methods for different regions. Moreover, using translated English queries for matching causes losses in semantic matching for different languages. Regions may be close, but cultural customs differ greatly, leading to a lack of distinctiveness in site searches. Embodiments of the present disclosure can construct differentiated features for sites, so that the trained model can adapt to the language differences of each site. The activation function of the neural network in the model is also adjusted, and an optimizer is used to improve the efficiency and learning capability of model training, enhancing the robustness of modeling expression differences across multiple languages.

After the above ranking model is constructed, it can be used for website searches to improve the accuracy of ranking, so that searches in various languages can obtain accurate and rich results.

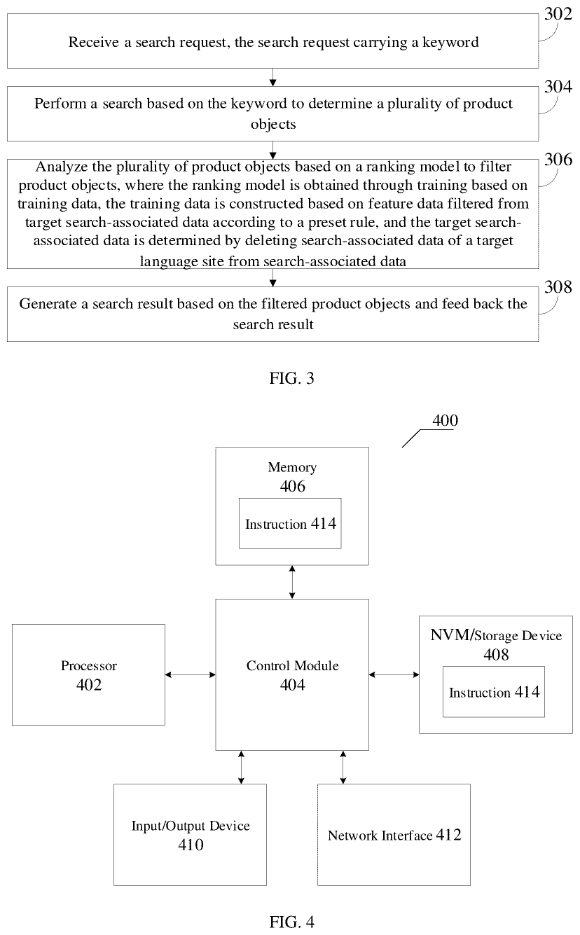

Referring to FIG. 3, a step flowchart of an embodiment of a product object search method of the present disclosure is shown.

Step 302, receive a search request, the search request carrying a keyword.

When a user browses a certain language site within a cross-border e-commerce website, the user can enter a corresponding keyword to search for a product object. Specifically, the keyword searched by the user on the website can be in the basic language of the website or in another language.

Step 304, perform a search based on the keyword to determine a plurality of product objects.

A search can be performed based on the search keyword. Specifically, the searched product objects can be product objects published in that language or product objects published in other languages. A plurality of product objects can be found, for example, more than 50 or more than 100.

Step 306, analyze the plurality of product objects based on a ranking model to filter product objects, where the ranking model is obtained through training based on training data, the training data is constructed based on feature data filtered from target search-associated data according to a preset rule, and the target search-associated data is determined by deleting a target language site from search-associated data.

Feature data of each product object can be determined, data of a target feature can be collected from the feature data and input into the ranking model; and the product objects are filtered based on the output result of the ranking model. For example, the ranking model can predict the click-through rate (CTR), visit rate, etc., of the product objects based on the target feature and perform ranking. The top K product objects are filtered.

Specifically, feature data of each feature can be extracted from the associated data, and correlation information between each feature data and behavior information can be analyzed; the target feature is filtered based on the correlation information.

For each product object, a site difference feature is constructed as the target feature. Constructing the site difference feature for each product object includes: generating a difference feature based on at least one of a language feature, a product object feature, and a conversion feature; determining a site feature of a site corresponding to the product object; and concatenating the difference feature and the site feature to obtain a corresponding site difference feature.

Generating the difference feature based on at least one of the language feature, the product object feature, and the conversion feature includes: acquiring an associated feature of the product object, the associated feature including an interaction depth feature of a language, a conversion rate feature of the product object, and a service quality feature of a seller user; determining the conversion feature of the product object based on the associated feature; and concatenating the conversion feature, the language feature, and the product object feature to determine a corresponding difference feature.

Step 308, generate a search result based on the filtered product objects and feed back the search result.

A search result is generated based on the filtered K product objects, and then the search result is fed back.

In summary, a search request carrying a keyword is received, then a search is performed based on the keyword to determine a plurality of product objects, and then the plurality of product objects are analyzed based on a ranking model to filter product objects. The ranking model is obtained through training based on training data, the training data is constructed based on feature data filtered from target search-associated data according to a preset rule, and the target search-associated data is determined by deleting a target language site from search-associated data. This enables support for searches on various language sites, more accurate ranking of product objects, and generation of a search result based on the filtered product objects to be fed back, providing users with accurate feedback results and improving user experience.

It should be noted that embodiments of the present disclosure may involve the use of user data. In practical applications, user-specific personal data may be used in the solutions described herein within the scope permitted by applicable laws and regulations (e.g., with explicit user consent, effective user notification, etc.) and in compliance with the requirements of applicable laws and regulations of the country where it is located.

It should be noted that, for the method embodiments, for the sake of simple description, they are all expressed as a series of action combinations. However, those skilled in the art should be aware that embodiments of the present disclosure are not limited by the described order of actions, because according to embodiments of the present disclosure, certain steps can be performed in other orders or simultaneously. Secondly, those skilled in the art should also be aware that the embodiments described in the specification are all preferred embodiments, and the actions involved are not necessarily required by embodiments of the present disclosure.

On the basis of the above embodiments, this embodiment also provides an apparatus for constructing a ranking model, applied in an electronic device such as a server-side device, the apparatus including:
a data filtering module, configured to delete search-associated data of a target language site from search-associated data to obtain target search-associated data;
a training data construction module, configured to filter feature data from the target search-associated data according to a preset rule to construct training data;
a model construction module, configured to construct a ranking model; and
a training module, configured to train the ranking model based on the training data to obtain a ranking model that satisfies specified conditions.

In summary, the search-associated data of a target language site is deleted from the search-associated data to obtain target search-associated data, thereby removing the influence of the target language on the data and making the target search-associated data for each language more balanced. Then, feature data is filtered from the target search-associated data according to a preset rule to construct training data, which allows for the selection of desired feature data as training data. A ranking model is then constructed and trained based on the training data to obtain a ranking model that satisfies specified conditions. This can eliminate the impact of uneven data distribution across various sites on low-traffic languages, resulting in a ranking model that supports various languages and enables accurate feedback for searches in all languages.

The data filtering module is further configured to acquire search-associated data for each language site; and determine data volume information corresponding to each language site based on the search-associated data, and determine the target language site based on the data volume information.

The training data construction module is configured to base on sampling information of the target search-associated data of each language site; and collect data of a target feature from the target search-associated data of each language site according to the sampling information to construct the training data.

The training data construction module is configured to determine data volume information and behavior information for each language site based on the target search-associated data of each language site; and determine the sampling information of the target search-associated data for each language site based on the data volume information and the behavior information.

The training data construction module is further configured to extract feature data of each feature from the associated data, and analyze correlation information between each feature data and the behavior information; and filter the target feature based on the correlation information.

The training data construction module is further configured to, for each product object, construct a site difference feature as the target feature.

The training data construction module is further configured to generate a difference feature based on at least one of a language feature, a product object feature, and a conversion feature; determine a site feature of a site corresponding to the product object; and concatenate the difference feature and the site feature to obtain a corresponding site difference feature.

The training data construction module is further configured to acquire an associated feature of the product object, the associated feature including an interaction depth feature of a language, a conversion rate feature of the product object, and a service quality feature of a seller user; determine the conversion feature of the product object based on the associated feature; and concatenate the conversion feature, the language feature, and the product object feature to determine a corresponding difference feature.

The model construction module is configured to determine an activation function, and add the activation function to the neural network model to construct the ranking model.

The data filtering module is configured to, in a case where the data volume information corresponding to a site exceeds a target threshold, determine the site as the target language site, where a language of the site is a target language.

Compared to unified modeling for all sites, where a single model suffers from uneven training for minority languages, embodiments of the present disclosure remove the data of target language sites with a large data proportion, such as English site data, while using the search data of the target language in multilingual sites to ensure that the model takes the target language into account. Embodiments of the present disclosure also adjust different sampling proportions for deep inquiry samples for different language sites. Thus, sites with a large amount of visit data are set to a lower sampling ratio, while sites with a low amount of visit data are sampled at a higher ratio, which can help alleviate the problem of sparse behavior data and long tail.

Compared to independent ranking modeling per site, which leads to too many models and causes losses in resources and online performance, as well as the problem of insufficient data volume in some low-traffic scenarios, cross-modeling, and severe losses in retention and conversion, embodiments of the present disclosure can delete weakly correlated features when determining training data, add core key attributes, and also construct differentiated features for language sites, eliminating the interference of uneven data distribution across various sites on the performance for low-traffic languages.

Compared to regional modeling, there is the problem of inconsistent division methods for different regions. Moreover, using translated English queries for matching causes losses in semantic matching for different languages. Regions may be close, but cultural customs differ greatly, leading to a lack of distinctiveness in site searches. Embodiments of the present disclosure can construct differentiated features for sites, so that the trained model can adapt to the language differences of each site. The activation function of the neural network in the model is also adjusted, and an optimizer is used to improve the efficiency and learning capability of model training, enhancing the robustness of modeling expression differences across multiple languages.

On the basis of the above embodiments, this embodiment also provides a product object search apparatus, applied in an electronic device such as a server-side device, the apparatus including:
a receiving module, configured to receive a search request, the search request carrying a keyword;
a searching module, configured to perform a search based on the keyword to determine a plurality of product objects;
a ranking module, configured to analyze the plurality of product objects based on a ranking model to filter product objects, where the ranking model is obtained through training based on training data, the training data is constructed based on feature data filtered from target search-associated data according to a preset rule, and the target search-associated data is determined by deleting a target language site from search-associated data; and
a feedback module, configured to generate a search result based on the filtered product objects and feed back the search result.

The ranking module is configured to collect data of a target feature from feature data of the product objects and input the data into the ranking model; and filter the product objects based on an output result of the ranking model.

In summary, a search request carrying a keyword is received, then a search is performed based on the keyword to determine a plurality of product objects, and then the plurality of product objects are analyzed based on a ranking model to filter product objects. The ranking model is obtained through training based on training data, the training data is constructed based on feature data filtered from target search-associated data according to a preset rule, and the target search-associated data is determined by deleting a target language site from search-associated data. This enables support for searches on various language sites, more accurate ranking of product objects, and generation of a search result based on the filtered product objects to be fed back, providing users with accurate feedback results and improving user experience.

An embodiment of the present disclosure also provides a non-transitory readable storage medium, on which one or more programs are stored. When the one or more programs are applied to a device, the device can be made to execute instructions for the method steps in the embodiments of the present disclosure.

An embodiment of the present disclosure also provides a computer-readable storage medium, where the computer-readable storage medium stores computer-executable instructions, and the computer-executable instructions, when executed by a processor, are used to implement the methods as described in the embodiments of the present disclosure.

An embodiment of the present disclosure also provides an electronic device, including: a processor, and a memory communicatively connected to the processor; the memory stores computer-executable instructions; the processor executes the computer-executable instructions stored in the memory to implement the methods as described in the embodiments of the present disclosure. In embodiments of the present disclosure, the electronic device includes a server, a terminal device, and other devices.

Embodiments of the present disclosure may be implemented as an apparatus configured as desired using any suitable hardware, firmware, software, or any combination of it. The apparatus may include electronic devices such as a server (cluster), a terminal, etc. FIG. 4 schematically illustrates an exemplary apparatus 400 that may be used to implement various embodiments described in the present disclosure.

For one embodiment, FIG. 4 shows an exemplary apparatus 400 having one or more processors 402, a control module (chipset) 404 coupled to at least one of the one or more processors 402, a memory 406 coupled to the control module 404, a non-volatile memory (NVM)/storage device 408 coupled to the control module 404, one or more input/output devices 410 coupled to the control module 404, and a network interface 412 coupled to the control module 404.

The processor 402 may include one or more single-core or multi-core processors. The processor 402 may include any combination of general-purpose processors or special-purpose processors (e.g., graphics processors, application processors, baseband processors, etc.). In some embodiments, the apparatus 400 can serve as a server-side device, terminal, or other device as described in the embodiments of the present disclosure.

In some embodiments, the apparatus 400 may include one or more computer-readable media (e.g., memory 406 or NVM/storage device 408) having instructions 414 and one or more processors 402 configured to execute the instructions 414 in combination with the one or more computer-readable media to implement modules for performing the actions described in the present disclosure.

For one embodiment, the control module 404 may include any suitable interface controller to provide any suitable interface to at least one of the one or more processors 402 and/or any suitable device or component in communication with the control module 404.

The control module 404 may include a memory controller module to provide an interface to the memory 406. The memory controller module may be a hardware module, a software module, and/or a firmware module.

The memory 406 may be used, for example, to load and store data and/or instructions 414 for the apparatus 400. For one embodiment, the memory 406 may include any suitable volatile memory, for example, a suitable DRAM. In some embodiments, the memory 406 may include Double Data Rate Type Four Synchronous Dynamic Random-Access Memory (DDR4 SDRAM).

For one embodiment, the control module 404 may include one or more input/output controllers to provide interfaces to the NVM/storage device 408 and the one or more input/output devices 410.

For example, the NVM/storage device 408 may be used to store data and/or instructions 414. The NVM/storage device 408 may include any suitable non-volatile memory (e.g., flash memory) and/or may include any suitable one or more non-volatile storage devices (e.g., one or more hard disk drives (HDDs), one or more compact disc (CD) drives, and/or one or more digital versatile disc (DVD) drives).

The NVM/storage device 408 may include storage resources that are part of the device on which the apparatus 400 is installed, or it may be accessible to the device without necessarily being part of the device. For example, the NVM/storage device 408 may be accessed over a network via the one or more input/output devices 410.

The one or more input/output devices 410 may provide an interface for the apparatus 400 to communicate with any other suitable device. The input/output devices 410 may include communication components, audio components, sensor components, etc. The network interface 412 may provide an interface for the apparatus 400 to communicate over one or more networks. The apparatus 400 may communicate wirelessly with one or more components of a wireless network according to any standard and/or protocol of one or more wireless network standards and/or protocols, for example, accessing a wireless network based on communication standards such as Bluetooth, WiFi, 2G, 3G, 4G, 5G, etc., or a combination of it for wireless communication.

In one embodiment, at least one of the one or more processors 402 may be packaged together with the logic of one or more controllers (e.g., a memory controller module) of the control module 404. In one embodiment, at least one of the one or more processors 402 may be packaged together with the logic of one or more controllers of the control module 404 to form a System-in-Package (SiP). In one embodiment, at least one of the one or more processors 402 may be integrated on the same die with the logic of one or more controllers of the control module 404. In one embodiment, at least one of the one or more processors 402 may be integrated on the same die with the logic of one or more controllers of the control module 404 to form a System-on-Chip (SoC).

In various embodiments, the apparatus 400 may be, but is not limited to: a terminal device such as a server, a desktop computing device, or a mobile computing device (e.g., a laptop computing device, a handheld computing device, a tablet, a netbook, etc.). In various embodiments, the apparatus 400 may have more or fewer components and/or a different architecture. For example, in some embodiments, the apparatus 400 includes one or more cameras, a keyboard, a liquid crystal display (LCD) screen (including a touchscreen display), a non-volatile memory port, multiple antennas, a graphics chip, an Application-Specific Integrated Circuit (ASIC), and speakers.

Specifically, in a detection device, a main control chip may be used as a processor or a control module, sensor data, positional information, etc., are stored in a memory or NVM/storage device, a sensor group may serve as an input/output device, and a communication interface may include a network interface.

An embodiment of the present disclosure also provides an electronic device, including: a processor; and a memory on which executable code is stored, where when the executable code is executed, it causes the processor to perform one or more of the methods in the embodiments of the present disclosure. In embodiments of the present disclosure, the memory may store various data, such as target files, file-application association data, and other various data, and may also include user behavior data, thereby providing a data basis for various processing.

An embodiment of the present disclosure also provides one or more machine-readable media on which executable code is stored, where when the executable code is executed, it causes a processor to perform one or more of the methods in the embodiments of the present disclosure.

As for the apparatus embodiments, since they are substantially similar to the method embodiments, their descriptions are relatively simple. For relevant parts, reference can be made to the descriptions of the method embodiments.

The various embodiments in this specification are described in a progressive manner. Each embodiment focuses on the differences from other embodiments, and the same or similar parts among the various embodiments can be referred to each other.

Embodiments of the present disclosure are described with reference to flowcharts and/or block diagrams of methods, terminal devices (systems), and computer program products according to embodiments of the present disclosure. It should be understood that each flow and/or block in the flowcharts and/or block diagrams, and combinations of flows and/or blocks in the flowcharts and/or block diagrams, can be implemented by computer program instructions. These computer program instructions may be provided to a processor of a general-purpose computer, a special-purpose computer, an embedded processor, or other programmable data processing terminal device to produce a machine, such that the instructions executed by the processor of the computer or other programmable data processing terminal device create an apparatus for implementing the functions specified in one or more flows of the flowchart and/or one or more blocks of the block diagram.

These computer program instructions may also be stored in a computer-readable memory that can direct a computer or other programmable data processing terminal device to function in a particular manner, such that the instructions stored in the computer-readable memory produce an article of manufacture including an instruction apparatus, which implements the functions specified in one or more flows of the flowchart and/or one or more blocks of the block diagram.

These computer program instructions may also be loaded onto a computer or other programmable data processing terminal device, such that a series of operational steps are performed on the computer or other programmable terminal device to produce a computer-implemented process, whereby the instructions executed on the computer or other programmable terminal device provide steps for implementing the functions specified in one or more flows of the flowchart and/or one or more blocks of the block diagram.

Although preferred embodiments of the present disclosure have been described, those skilled in the art can make additional changes and modifications to these embodiments once they have learned the basic creative concepts. Therefore, the appended claims are intended to be interpreted as including the preferred embodiments and all changes and modifications that fall within the scope of the embodiments of the present disclosure.

Finally, it should also be noted that in this application, relational terms such as “first” and “second” are used merely to distinguish one entity or operation from another, and do not necessarily require or imply any such actual relationship or order between these entities or operations. Moreover, the terms “including,” “comprising,” or any other variation of it are intended to cover a non-exclusive inclusion, such that a process, method, article, or terminal device that includes a series of elements not only includes those elements but also includes other elements not explicitly listed, or elements inherent to such a process, method, article, or terminal device. Without more constraints, an element defined by the statement “including a . . . ” does not exclude the existence of other identical elements in the process, method, article, or terminal device that includes the element.

The foregoing provides a detailed description of a hand modeling method, a processing method based on a hand model, an electronic device, and a storage medium provided by the present disclosure. Specific examples have been used herein to explain the principles and implementation methods of the present disclosure. The description of the above embodiments is only for helping to understand the method and its core ideas of the present disclosure. At the same time, for a person of ordinary skill in the art, there will be changes in the specific implementation methods and application scope based on the ideas of the present disclosure. In summary, the content of this specification should not be construed as a limitation on the present disclosure.

1. A method for constructing a ranking model, comprising:
deleting search-associated data of a target language site from search-associated data to obtain target search-associated data;
filtering feature data from the target search-associated data according to a preset rule to construct training data;
constructing a ranking model; and
training the ranking model based on the training data to obtain a ranking model that satisfies specified conditions.

2. The method of claim 1, wherein before deleting the search-associated data of the target language site from the search-associated data to obtain the target search-associated data, the method further comprises:
acquiring search-associated data for each language site; and
determining data volume information corresponding to each language site based on the search-associated data, and determining the target language site based on the data volume information.

3. The method of claim 2, wherein filtering the feature data from the target search-associated data according to the preset rule to construct the training data comprises:
obtaining sampling information of the target search-associated data of each language site; and
collecting data of a target feature from the target search-associated data of each language site according to the sampling information to construct the training data.

4. The method of claim 3, wherein obtaining the sampling information of the target search-associated data of each language site comprises:
determining data volume information and behavior information for each language site based on the target search-associated data of each language site; and
determining the sampling information of the target search-associated data for each language site based on the data volume information and the behavior information.

5. The method of claim 3, wherein the method further comprises:
extracting feature data of each feature from the associated data, and analyzing correlation information between each feature data and behavior information; and
filtering the target feature based on the correlation information.

6. The method of claim 3, wherein the method further comprises:
for each product object, constructing a site difference feature as a target feature.

7. The method of claim 6, wherein constructing the site difference feature for each product object comprises:
generating a difference feature based on at least one of a language feature, a product object feature, and a conversion feature;
determining a site feature of a site corresponding to the product object; and
concatenating the difference feature and the site feature to obtain a corresponding site difference feature.

8. The method of claim 7, wherein generating the difference feature based on at least one of the language feature, the product object feature, and the conversion feature comprises:
acquiring an associated feature of the product object, the associated feature including an interaction depth feature of a language, a conversion rate feature of the product object, and a service quality feature of a seller user;
determining the conversion feature of the product object based on the associated feature; and
concatenating the conversion feature, the language feature, and the product object feature to determine a corresponding difference feature.

9. The method of claim 1, wherein constructing the ranking model comprises:
determining an activation function, and adding the activation function to a neural network model to construct the ranking model.

10. The method of claim 2, wherein determining the target language site based on the data volume information comprises:
in a case where the data volume information corresponding to a site exceeds a target threshold, determining the site as the target language site, wherein a language of the site is a target language.

11. The method of claim 1, wherein the search-associated data includes at least one of the following: product object data, keywords corresponding to product objects, search click data, and store data.

12. A non-transitory computer-readable storage medium configured with instructions executable by one or more processors to cause the one or more processors to perform the method of claim 1.

13. An electronic device comprising:
one or more processors; and
one or more computer-readable memories coupled to the one or more processors and having instructions stored thereon that are executable by the one or more processors to perform the method of claim 1.

14. A product object search method, comprising:
receiving a search request, the search request carrying a keyword;
performing a search based on the keyword to determine a plurality of product objects;
analyzing the plurality of product objects based on a ranking model to filter product objects, wherein the ranking model is obtained through training based on training data, the training data is constructed based on feature data filtered from target search-associated data according to a preset rule, and the target search-associated data is determined by deleting search-associated data of a target language site from search-associated data; and
generating a search result based on the filtered product objects and feeding back the search result.

15. The method of claim 14, where analyzing the plurality of product objects based on the ranking model to filter the product objects comprises:
collecting data of a target feature from feature data of the product objects and inputting the data into the ranking model; and
filtering the product objects based on an output result of the ranking model.

16. The method of claim 14, wherein the target language site is determined based on data volume information corresponding to each language site.

17. The method of claim 14, wherein the search-associated data includes product object data, keywords corresponding to product objects, search click data, and store data.

18. A non-transitory computer-readable storage medium configured with instructions executable by one or more processors to cause the one or more processors to perform the method of claim 14.

19. An electronic device comprising:
one or more processors; and
one or more computer-readable memories coupled to the one or more processors and having instructions stored thereon that are executable by the one or more processors to perform the method of claim 14.
